(19) United States
(12) Patent Application Publication
(10) Pub. No.: US 2017/0037500 A1
(43) Pub. Date: Feb. 9, 2017

(54) METHOD OF PREPARING INSULATION COATING

(71) Applicant: National Taipei University of Technology, Taipei (TW)

(72) Inventors: Yung-Chin Yang, Taipei (TW); Min-Chi Tsai, Taipei (TW); Ching-Jer Huang, Taipei (TW); Yen-Tsen Lin, Taipei (TW); Tsung-Mo Tien, Taipei (TW); I-Lun Chung, Taipei (TW)

(21) Appl. No.: 15/079,357

(22) Filed: Mar. 24, 2016

(30) Foreign Application Priority Data
Aug. 7, 2015 (TW) 104125863

(51) Int. Cl. C23C 4/04; C23C 26/00; C23C 28/00; B05D 1/12

(52) U.S. Cl. CPC C23C 4/04; B05D 1/12; C23C 26/00; C23C 28/00

(57) ABSTRACT

The present invention discloses a method of preparing insulation coating. The method comprises: providing a powder of polymer material, a graphite powder, and a substrate, wherein the powder of the polymer material is an epoxy powder or a polyethylene (PE) powder. Next, forming a mixture via mixing the powder of polymer material and the graphite powder. Then, utilizing a thermal spray device to spray the mixture on the substrate and then cooling the substrate to form an insulation coating. The method possesses advantages of increased production efficiency and reduced cost, and provides an insulation coating with good sound insulation properties.

### CROSS REFERENCE

The non-provisional application claims priority from Taiwan Patent Application No. 104125863, filed on Aug. 7, 2015, the content thereof is incorporated by reference herein.

### FIELD OF THE INVENTION

The invention relates to a method of preparing insulation coating, and more particularly to forming an insulation coating via spraying the mixture on a substrate, wherein the mixture is a combination of an epoxy powder and a graphite powder or a polyethylene (PE) powder and the graphite powder.

### BACKGROUND OF THE INVENTION

Traditional types of noise barriers are created as a sponge inner surface and utilize the sound absorption characteristics of the sponge to absorb noise.

However, after prolonged use of the noise barrier makes the sponge gradually deteriorate. The sponge of the noise needs to be replaced to maintain the effectiveness of the noise barrier. The maintenance process is more complicated and time consuming since the noise barrier needs to be removed from the wall and repaired.

China patent 103710873A discloses a non woven cloth sound absorbing cotton containing graphene. The non woven cloth sound absorbing cotton is composed of a top face layer, a back layer and a fiber cotton layer clamped between the top face layer and the back layer, the top face layer and the back layer are made of non woven cloth, and the non woven cloth is formed by weight, 100 parts of isostatic polypropylene, 5-7 parts of vinyl acetate, 2-3 parts of acrylic acid-2-hydroxy propyl ester, 1-2 parts of isocyanate, 4-5 parts of silica, 2-3 parts of sodium tripolyphosphate, 12-15 parts of epoxidized soybean oil, 1-2 parts of graphene, 1-2 parts of cetyl trimethyl ammonium bromide, 3-4 parts of radix isatidis, 1-2 parts of dyer woad leaf, 2-3 parts of houttuynia cordata and 4-5 parts of auxiliary through a melt-blowing method.

The non woven cloth which is excellent in mechanical performance and dense in cloth quality is taken as an outer layer material. Utilizing the non woven cloth the leakage of interlayer fiber cotton is effectively prevented, environment friendliness and safety is provided, heat resistance and flame retardancy is increased, sound absorbing and denoising and the like is realized, and the non woven cloth sound absorbing cotton has numerous applications.

However, the non woven fiber cloth material deteriorates after long-term exposure to the sun and rain. Therefore, like the insulation above, the sound-absorbing cotton material still has room for improvement.

In view of the foregoing, a need exists in the art for an improved noise barrier using non woven cloth as an insulation material.

### SUMMARY OF THE INVENTION

Accordingly, to solve the above problems, an object of the present invention is to provide an insulation coating. The insulation coating has numerous advantages such as a simple structure, relatively low cost, and good sound insulation.

In order to accomplish the above objective and more, the present invention discloses providing a powder of polymer material, a graphite powder, and a substrate, wherein the powder of polymer material is an epoxy powder or a polyethylene (PE) powder; forming a mixture via mixing the powder of polymer material and the graphite powder, wherein the volume percentage concentration of the graphite powder is between 5˜25 vol %; heating the mixture to a temperature between 350˜650° C.; spraying the mixture on the substrate; and cooling the mixture to form an insulation coating.

### BRIEF DESCRIPTION OF THE DRAWINGS

FIG. 1 is a flowchart of a first embodiment of the present invention;

FIG. 2 is a schematic view of the first embodiment of the present invention;

FIG. 3a is a flowchart of a second embodiment of the present invention;

FIG. 3b is a schematic view of the second embodiment of the present invention;

FIG. 4a is an absorption coefficient-frequency view of an epoxy powder mixed with a normal graphite powder of the present invention;

FIG. 4b is an absorption coefficient-frequency view of an epoxy powder mixed with an expanded graphite powder of the present invention;

FIG. 5a is an absorption coefficient-frequency view of a polyethylene powder mixed with a normal graphite powder of the present invention; and

FIG. 5b is an absorption coefficient-frequency view of a polyethylene powder mixed with an expanded graphite powder of the present invention.

### DETAILED DESCRIPTION OF THE INVENTION

In order to describe details of preferred embodiments of the present invention, description of the structure, and the application as well as the steps are made with reference to the accompanying drawings. It is learned that after the description, any variation, modification or the like to the structure and the steps of the embodiments of the preferred embodiments of the present invention is easily made available to any person skilled in the art. Thus, the following description is only for illustrative purpose and does not, in any way, try to limit the scope of the present invention.

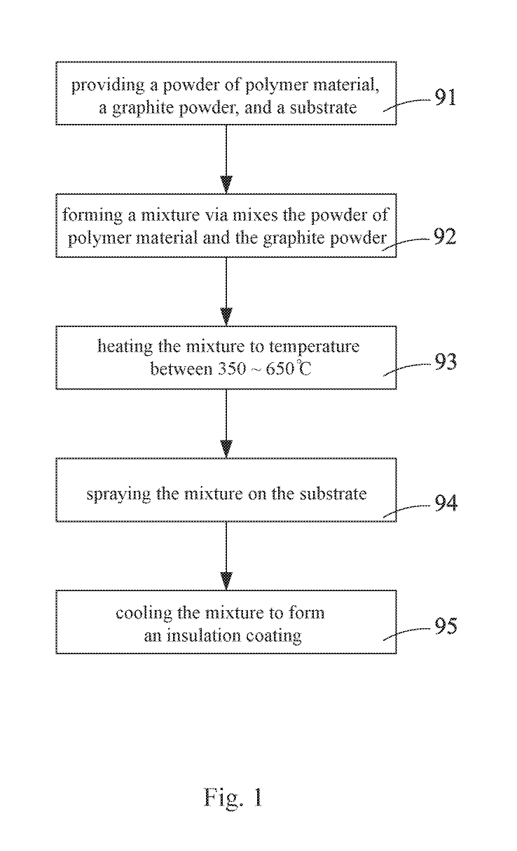

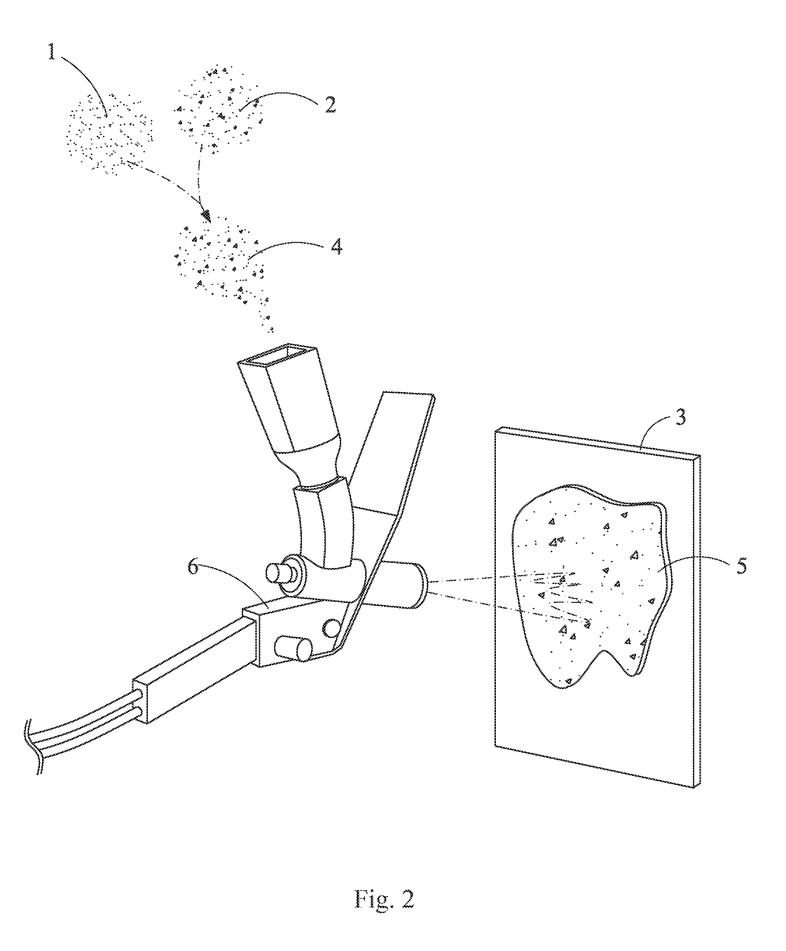

With reference to FIGS. 1 and 2 of a first embodiment of the present invention, the method of preparing an insulation coating 5 comprises the following steps:

Step 91: providing a powder of polymer material 1, a graphite powder 2, and a substrate 3. In the first embodiment, the powder of polymer material 1 is an epoxy powder or a polyethylene (PE) powder, the graphite powder 2 is a normal graphite powder or an expanded graphite powder, and the substrate 3 is a metal substrate, a stone substrate or a cement substrate.

Step 92: forming a mixture 4 via mixing the powder of polymer material 1 and the graphite powder 2. The present invention forms the mixture 4 via utilizing different volume percentage concentrations of the normal graphite powder or the expanded graphite powder respectively mixed into the epoxy powder or the polyethylene powder. The ingredients of the mixture 4 as shown in table one, are preferably, with a volume percentage concentration of the graphite powder 2 between 5˜25 vol %.

TABLE ONE

| | normal graphite | | | expanded graphite | | |
|---|---|---|---|---|---|---|
| | powder (vol %) | | | powder (vol %) | | |
| epoxy powder | 5 vol % | 10 vol % | 20 vol % | 5 vol % | 10 | 20 |
| | | | | | vol % | vol % |
| polyethylene | 5 vol % | 10 vol % | 20 vol % | 5 vol % | 10 | 20 |
| powder | | | | | vol % | vol % |

Step 93: heating the mixture 4 to a temperature between 350˜650° C.

Step 94: spraying the mixture 4 on the substrate 3. The present invention utilizes a spray device 6 that heats the mixture 4 to a temperature between 350˜650° C. and sprays the molten mixture 4 on the substrate 3, wherein the spray device 6 is a thermal spray device. It is noted that the surface of the substrate 3 may be sand sprayed to remove oxides or impurities and increase adhesion to the substrate 3.

Step 95: cooling the mixture 4 to form an insulation coating 5. The mixture 4 is cooled to room temperature and forms an insulation coating 5, preferably the thickness of the insulation coating 5 is between 0.4˜1.3 cm.

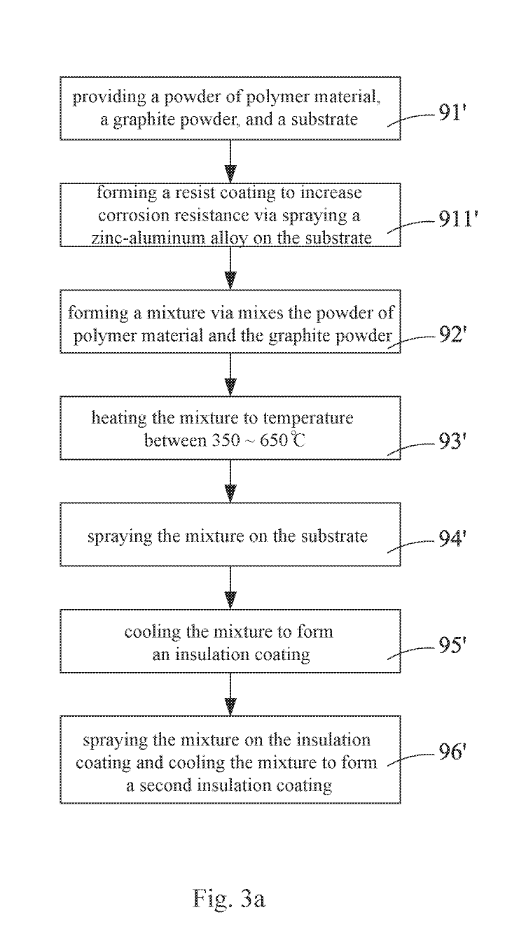

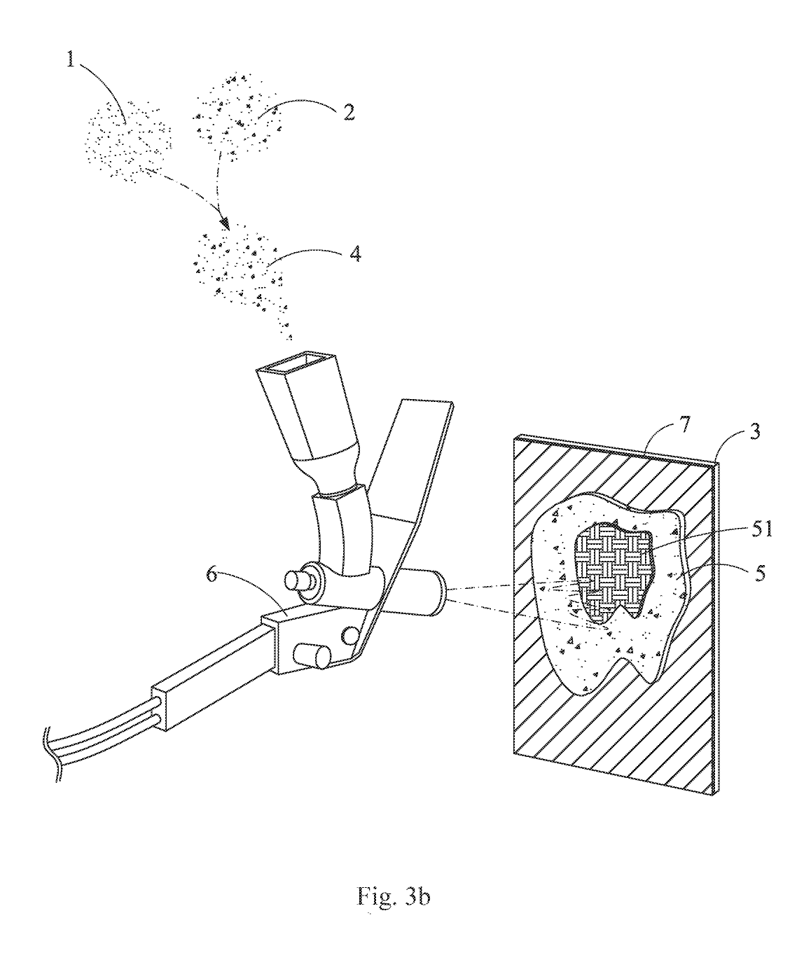

With reference to FIGS. 3a and 3b of a second embodiment of the present invention comprises, before Step 92′: forming a mixture 4 via mixing the powder of polymer material 1 and the graphite powder 2 further comprising a step 911′: forming a resist coating 7 to increase corrosion resistance via spraying a zinc-aluminum alloy on the substrate 3. The resist coating 7 is used for increasing corrosion resistance and extending the life of the substrate 3, preferably the thickness of the resist coating 7 is between 200˜700 μm.

In the second embodiment of the present invention, after Step 95′ comprises: cooling the mixture 4 to form an insulation coating 5 further comprising a step 96′: spraying the mixture 4 on the insulation coating 5 and cooling the mixture 4 to form a second insulation coating 51. The thickness of the second insulation coating 51 is preferably between 0.4˜1.3 cm.

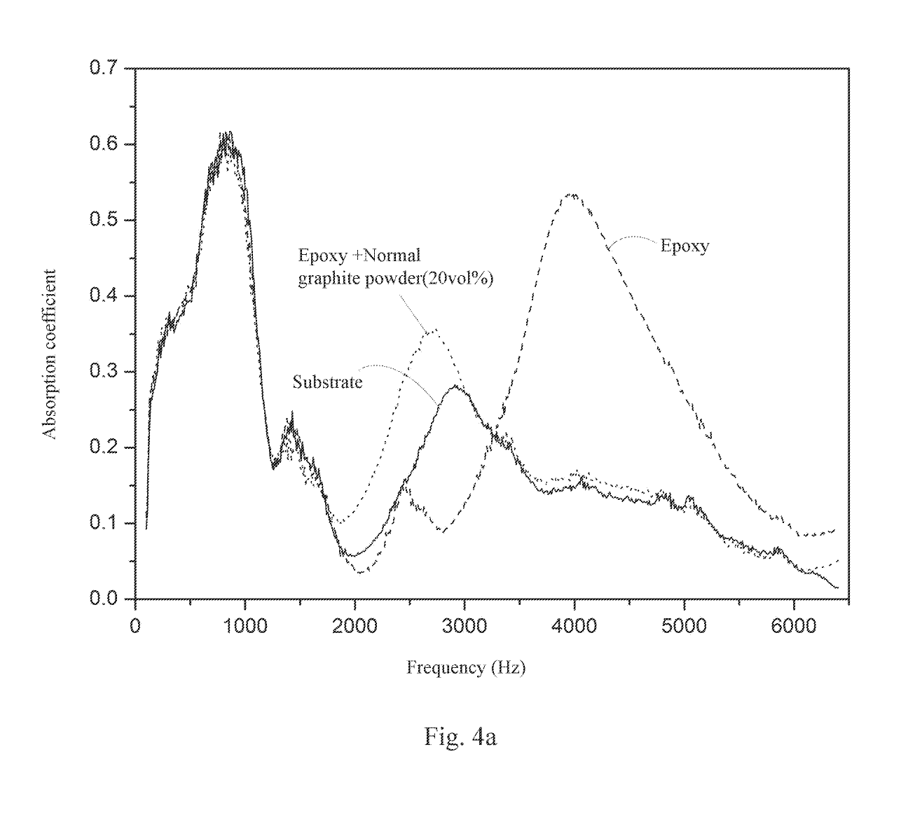

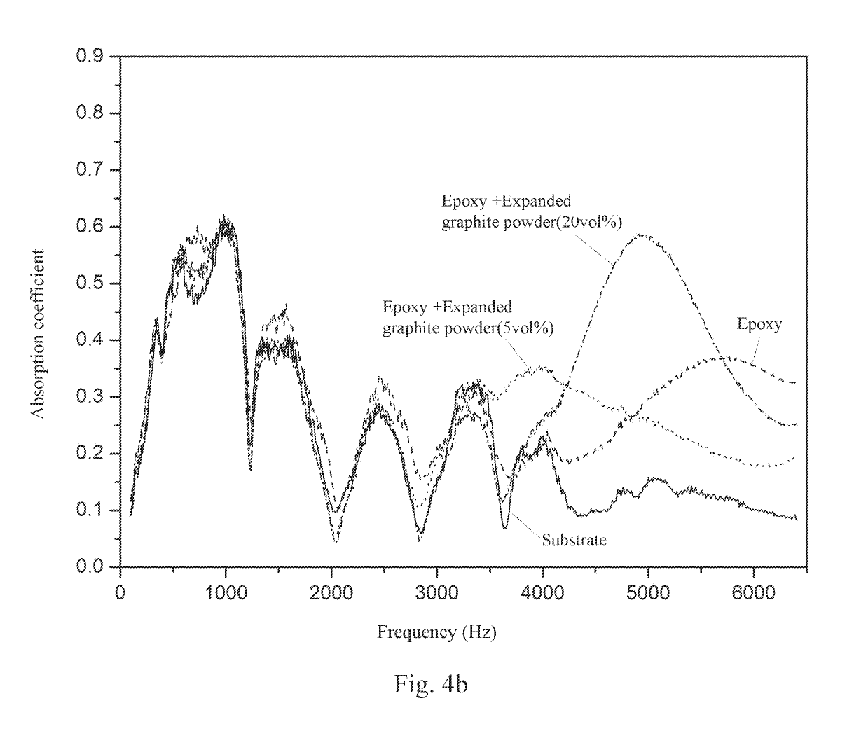

With reference to FIG. 4a of an absorption coefficient-frequency view of an epoxy powder mixed with a normal graphite powder of the present invention. The epoxy has a network structure. The network structure may enhance the viscoelastic and sound insulation properties. According to FIG. 4a, the absorption coefficient of the epoxy is better than the substrate, and the epoxy mixed with normal graphite can change the absorption frequency of the sound waves.

With reference to FIG. 4b of an absorption coefficient-frequency view of an epoxy powder mixed with an expanded graphite powder of the present invention. Since the granule of the expanded graphite powder is bigger than the normal graphite powder, the structure and absorption coefficient of the insulation coating with expanded graphite powder is different than the insulation coating with normal graphite powder. According to FIG. 4b, the maximum of the absorption coefficient of epoxy powder mixed with 5 vol % expanded graphite powder is located at 4000 Hz, and the maximum of the absorption coefficient of epoxy powder mixed with 20 vol % expanded graphite powder is located at 5000 Hz.

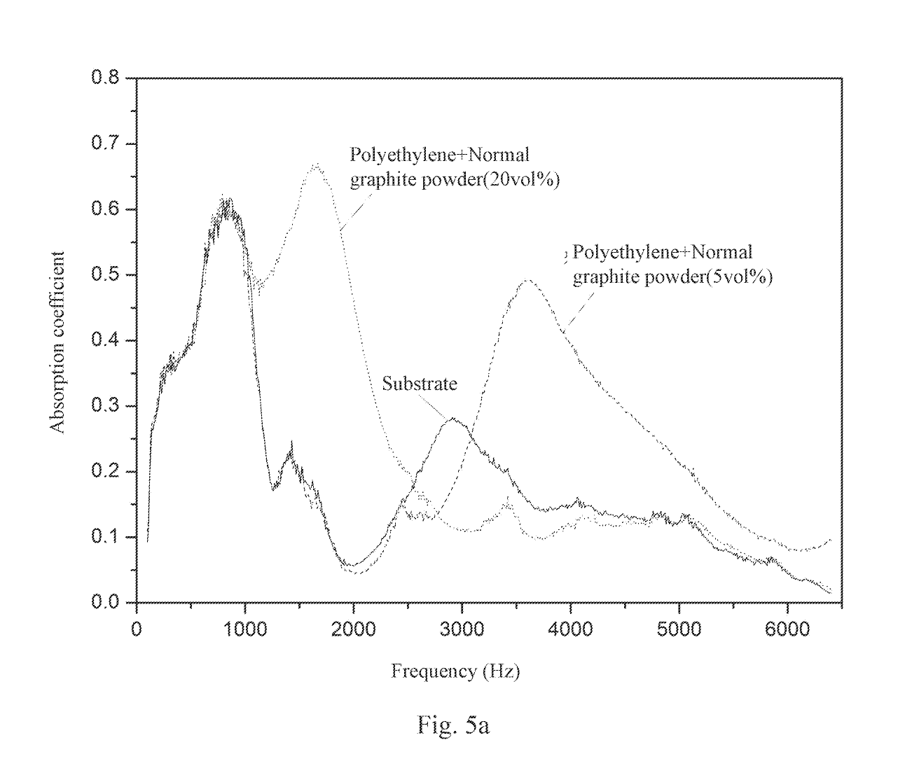

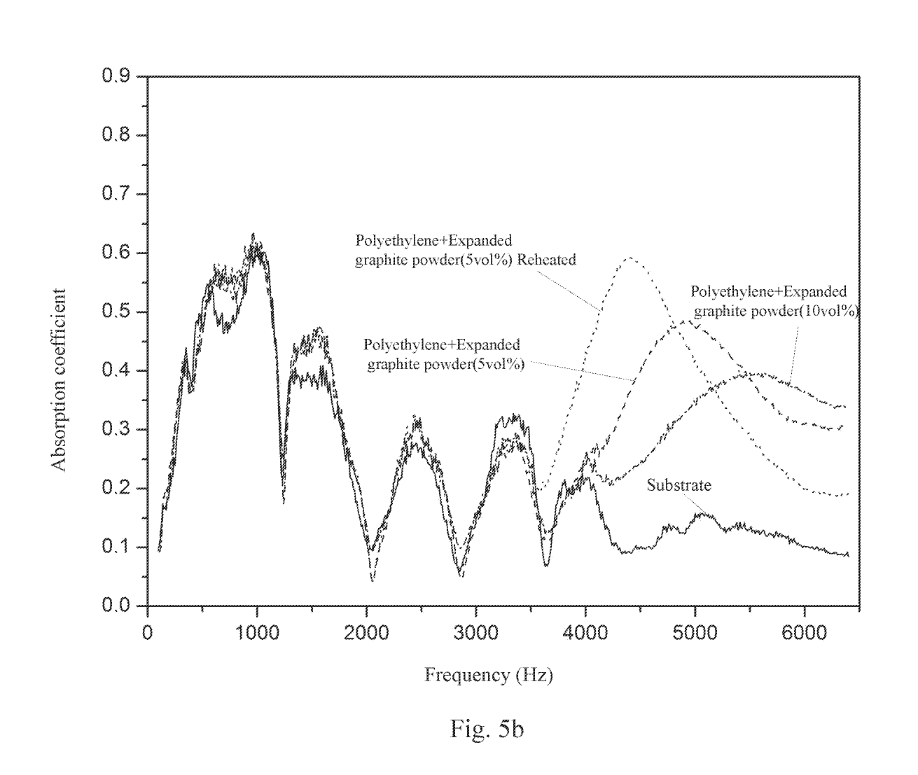

With reference to FIG. 5a of an absorption coefficient-frequency view of a polyethylene powder mixed with a normal graphite powder of the present invention. The polyethylene powder mixed with different volume percentage concentrations of the normal graphite powder with good sound insulation at 1700 Hz and 3700 Hz. The reason is that the situation varies with different volume percentage concentrations of the normal graphite powder dispersed in the mixture. In higher concentrations, the normal graphite powder agglomerates in the mixture to form larger particles of graphite powder which can correspond to the low-frequency sound waves. In lower concentrations, the normal graphite powder spread evenly in the mixture can correspond to the high-frequency sound waves.

With reference to FIGS. 1, 2 and 5b, FIG. 5b is an absorption coefficient-frequency view of a polyethylene powder mixed with an expanded graphite powder of the present invention. The volume percentage concentration of the expanded graphite powder will influence the frequency bands of the sound insulation.

In an embodiment of the present invention, after Step 95 comprises: cooling the mixture 4 to form an insulation coating 5 further comprising the following step: heating the surface of the insulation coating 5 to a temperature between 350˜650° C.; and cooling the mixture 4 to room temperature. According to FIG. 5b, reheating the surface of the insulation coating 5 can influence the frequency bands and promote the sound insulation property.

As mentioned above, the present invention provides preparing an insulation coating that has numerous advantages such as simple structure, ease of manufacturing, longer service life, relatively low cost, and good sound insulation properties.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of preparing insulation coating, the method comprising the steps of:
providing a powder of polymer material, a graphite powder, and a substrate, wherein the powder of polymer material comprises an epoxy powder or a polyethylene (PE) powder;
forming a mixture via mixing the powder of polymer material and the graphite powder, wherein the volume percentage concentration of the graphite powder is between 5˜25 vol %;
heating the mixture to a temperature between 350˜650° C.;
spraying the mixture on the substrate; and
cooling the mixture to form an insulation coating.

2. The method of preparing insulation coating as claimed in claim 1, wherein the graphite powder comprises an expanded graphite powder.

3. The method of preparing insulation coating as claimed in claim 1, wherein spraying the mixture on the substrate utilizes a spray device to spray the mixture on the substrate.

4. The method of preparing insulation coating as claimed in claim 3, wherein the spray device is a thermal spray device.

5. The method of preparing insulation coating as claimed in claim 1, wherein the method further comprises the step of:
forming a resist coating to increase corrosion resistance via spraying a zinc-aluminum alloy on the substrate.

6. The method of preparing insulation coating as claimed in claim 5, wherein the thickness of the resist coating is between 200˜700 μm.

7. The method of preparing insulation coating as claimed in claim 1, wherein cooling the substrate to form an insulation coating further comprises the step of:
spraying the mixture on the insulation coating and cooling the mixture to form a second insulation coating.

8. The method of preparing insulation coating as claimed in claim 5, wherein cooling the substrate to form an insulation coating further comprises the step of:
spraying the mixture on the insulation coating and cooling the mixture to form a second insulation coating.

9. The method of preparing insulation coating as claimed in claim 6, wherein cooling the substrate to form an insulation coating further comprises the step of:
spraying the mixture on the insulation coating and cooling the mixture to form a second insulation coating.

10. The method of preparing insulation coating as claimed in claim 7, wherein the thickness of the second insulation coating is between 0.4˜1.3 cm.

11. The method of preparing insulation coating as claimed in claim 8, wherein the thickness of the second insulation coating is between 0.4˜1.3 cm.

12. The method of preparing insulation coating as claimed in claim 9, wherein the thickness of the second insulation coating is between 0.4˜1.3 cm.

13. The method of preparing insulation coating as claimed in claim 1, wherein the thickness of the insulation coating is between 0.4˜1.3 cm.

14. The method of preparing insulation coating as claimed in claim 1, wherein cooling the substrate to form an insulation coating further comprises the steps of:
heating the surface of the insulation coating to a temperature between 350˜650° C.; and
cooling the mixture to room temperature.
